(19) United States
(12) Patent Application Publication
(10) Pub. No.: US 2026/0230263 A1
(43) Pub. Date: Aug. 6, 2026

(54) SIGNALING OF CSI-RS CONFIGURATION FOR ULTRA LARGE ANTENNA ARRAY

(71) Applicant: Telefonaktiebolaget LM Ericsson (publ), Stockholm (SE)

(72) Inventors: Siva Muruganathan, Stittsville, Ontario (CA); Mattias Frenne, Uppsala (SE); Andreas Nilsson, Göteborg (SE); Shiwei Gao, Nepean, Ontario (CA)

(21) Appl. No.: 19/151,668

(22) PCT Filed: Feb. 16, 2024
(86) PCT No.: PCT/IB2024/051518

§ 371 Date: Jul. 29, 2025

Related U.S. Application Data
(60) Provisional application No. 63/485,811, filed on Feb. 17, 2023.

(51) Int. Cl. H04L 5/00

(52) U.S. Cl. CPC H04L 5/0051; H04L 5/0094

(57) ABSTRACT

Systems and methods related to signaling of Channel State Information Reference Signal (CSI-RS) configuration for ultra large antenna arrays are disclosed. In one embodiment, a method performed by a User Equipment (UE) comprises receiving, from a network node, a first indication of starting resource elements (REs) for a first subset of code division multiplexing (CDM) groups in a first set of time-frequency resource units and a second indication of starting REs for a second subset of CDM groups in a second set of time-frequency resource units. The method further comprises receiving a first subset of non-zero power (NZP) CSI-RS ports in the first subset of CDM groups, in accordance with the first indication, and receiving a second subset of NZP CSI-RS ports in the second subset of CDM groups, in accordance with the second indication.

### RELATED APPLICATIONS

This application claims the benefit of provisional patent application Ser. No. 63/485,811, filed Feb. 17, 2023, the disclosure of which is hereby incorporated herein by reference in its entirety.

### TECHNICAL FIELD

The present disclosure relates to a cellular communications network and, more specifically, to configuration of Channel State Information (CSI) Reference Signals (CSI-RS) in a cellular communications system.

### BACKGROUND

### Codebook-Based Precoding

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

A core component of the fifth Generation (5G) wireless network or New Radio (NR) is the support of MIMO antenna deployments and MIMO related techniques such as spatial multiplexing. Spatial multiplexing can be used to increase data rates in favorable channel conditions. FIG. 1 shows an example of spatial multiplexing in NR. An information carrying symbol vector s is multiplied by an N_{T}×r precoding matrix or precoder W, which serves to distribute the transmit energy in a subspace of the N_{T} dimensional vector space. The precoding matrix is typically selected from a codebook of possible precoding matrices, and typically indicated by means of a precoding matrix indicator (PMI), which specifies a unique precoding matrix in the codebook for a given number of symbol streams. The r symbols in s each correspond to a MIMO layer and r is referred to as the transmission rank, which equals to the number of columns of the precoder W. In this way, spatial multiplexing is achieved since multiple symbols can be transmitted simultaneously over the same time/frequency resource element (RE). The number of symbols r is typically adapted to suit the current channel properties.

NR uses Orthogonal Frequency Division Multiplexing (OFDM) in downlink. The received N_{R}×1 vector yₙ at a User Equipment (UE) on a certain RE can be expressed as

$${y}_{n} = {H}_{n} {Ws}_{n} + {e}_{n}$$

where eₙ is a receiver noise/interference vector. The precoder W can be constant over frequency (i.e., wideband), or frequency selective (i.e., per subband).

The precoder W is chosen to match the characteristics of the N_{R}×N_{T} MIMO channel matrix Hₙ, resulting in so-called channel dependent precoding. This is also commonly referred to as closed-loop precoding.

In closed-loop precoding, the UE feeds back recommendations on a suitable precoder to the gNodeB (gNB) in the form of a PMI based on downlink channel measurements. For that purpose, the UE is configured with a channel state information (CSI) report configuration including CSI reference signals (CSI-RS) for channel measurements and a codebook of candidate precoders. In addition to precoders, the feedback may also include a rank indicator (RI) and one or two channel quality indicators (CQIs). RI, PMI, and CQI are part of a CSI feedback. In NR, CSI feedback can be either wideband, where one CSI is reported for the entire channel bandwidth, or frequency-selective, where one CSI is reported for each subband, which is defined as a number of contiguous physical resource blocks (PRBs) ranging between 4-32 PRBs depending on the band width part (BWP) size.

Given the CSI feedback from the UE, the gNB determines the transmission parameters it wishes to use to transmit to the UE, including the precoding matrix, transmission rank, and modulation and coding scheme (MCS).

### 2D Antenna Arrays

Two-dimensional antenna arrays are widely used and such antenna arrays can be described by a number of antenna ports, N₁, in a first dimension (e.g., the horizontal dimension), a number of antenna ports, N₂, in the second dimension perpendicular to the first dimension (e.g., the vertical dimension), and a number of polarizations Nₚ. The total number of antenna ports is thus N=N₁N₂Nₚ. The concept of an antenna port is non-limiting in the sense that it can refer to any virtualization (e.g., linear mapping) to the physical antenna elements. For example, pairs of physical antenna elements could be fed the same signal, and hence share the same virtualized antenna port.

An example of a 4×4 (i.e., N₁×N₂,) array with dual-polarized antenna elements (i.e., Nₚ=2) is illustrated below in FIG. 2.

Precoding may be interpreted as multiplying the signal to be transmitted by a set of beamforming weights on the antenna ports prior to transmission. A typical approach is to tailor the precoder to the antenna form factor, i.e. taking into account N₁, N₂, and Nₚ when designing the precoder codebook.

### Channel State Information Reference Signals (CSI-RS)

For CSI measurement and feedback, CSI-RS are defined. A CSI-RS is transmitted on an antenna port at the gNB and is used by a UE to measure downlink channel between the antenna port and each of the UE's receive antenna ports. The transmit antenna ports are also referred to as CSI-RS ports. The currently supported number of CSI-RS ports in NR are {1,2,4,8,12,16,24,32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 3 shows an example of CSI-RS REs for 12 antenna ports, where 1 RE per RB per port is shown.

In addition, interference measurement resource (IMR) is also defined in NR for a UE to measure interference. An IMR resource contains 4 REs, either 4 adjacent RE in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI. Furthermore, a UE in NR may be configured to measure interference based on one or multiple NZP CSI-RS resource.

NZP CSI-RS configuration details are given in clause 7.4.1.5 of 3GPP TS 38.211 V17.3.0.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource setting for channel measurement.
An IMR resource set for interference measurement
Optionally, a CSI-RS resource set for interference measurement
Time-domain behavior, i.e. periodic, semi-persistent, or aperiodic reporting
Frequency granularity, i.e. wideband or subband
CSI parameters to be reported such as RI, PMI, CQI, and CSI-RS resource indicator (CRI) in case of multiple CSI-RS resources in a resource set
Codebook types, i.e. type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

### SUMMARY

Systems and methods related to signaling of Channel State Information (CSI) Reference Signal (CSI-RS) configuration for ultra large antenna arrays are disclosed. In one embodiment, a method performed by a User Equipment (UE) comprises receiving, from a network node, a first indication of starting resource elements (REs) for a first subset of code division multiplexing (CDM) groups in a first set of time-frequency resource units and receiving, from the network node, a second indication of starting REs for a second subset of CDM groups in a second set of time-frequency resource units. The method further comprises receiving a first subset of non-zero power (NZP) CSI-RS ports in the first subset of CDM groups, in accordance with the first indication of the starting REs for the first subset of CDM groups in the first set of time-frequency resource units. The method further comprises receiving a second subset of NZP CSI-RS ports in the second subset of CDM groups, in accordance with the second indication of the starting REs for the second subset of CDM groups in the second set of time-frequency resource units. In this manner, a large CSI-RS resource can be flexibly configured so that it is easier in deployment to avoid other signals and channels.

In one embodiment, the first set of time-frequency resource units is a first subset of time-frequency resource units configured for a NZP CSI-RS resource, and the second set of time-frequency resource units is a second subset of time-frequency resource units configured for the NZP CSI-RS resource.

In one embodiment, the first set of time-frequency resource units is configured for a first NZP CSI-RS resource, and the second set of time-frequency resource units is configured for a second NZP CSI-RS resource. In one embodiment, the first NZP CSI-RS resource and the second NZP CSI-RS resource are linked to form an overall CSI-RS resource.

In one embodiment, the first set of time-frequency resource units comprises a first subset of Physical Resource Blocks (PRBs) in a slot, and the second set of time-frequency resource units comprises a second subset of PRBs in the slot, wherein the first subset of PRBs in the slot is mutually exclusive to the second subset of PRBs in the slot. In one embodiment, the first subset of PRBs is the even PRBs in the slot, and the second subset of PRBs is the odd PRBs in the slot.

In one embodiment, the first indication of the starting REs for the first subset of CDM groups in the first set of time-frequency resource units comprises a first indication of starting subcarriers of the first subset of CDM groups in the first set of time-frequency resource units, and the second indication of starting REs for the second subset of CDM groups in the second set of time-frequency resource units comprises a second indication of staring subcarriers of the second subset of CDM groups in the second set of time-frequency resource units.

In one embodiment, the number of CDM groups in the first subset of CDM groups is the same as the number of CDM group in the second subset of CDM groups.

In one embodiment, the number of CDM groups in the first subset of CDM groups is different than the number of CDM group in the second subset of CDM groups.

In one embodiment, the first indication and the second indication are separate bitmaps.

In one embodiment, the first indication and the second indication concatenated into a single bitmap.

In one embodiment, the first indication and the second indication are each a set or list of integer or enumerated values.

In one embodiment, the first indication and the second indication are a common configuration for both the first subset of CDM groups in the first set of time-frequency resource units and the second subset of CDM groups in the second set of time-frequency resource units.

In one embodiment, the first set of time-frequency resource units comprises a plurality of PRBs in a first slot, and the second set of time-frequency resource units comprises a plurality of PRBs in a second slot. In one embodiment, the second slot is adjacent in time to the first slot. In one embodiment, the first indication of the starting REs for the first subset of CDM groups comprises a first indication of starting symbols of the first subset of CDM groups in the first slot, and the second indication of the starting REs for the second subset of CDM groups comprises a second indication of starting symbols of the second subset of CDM groups in the second slot. In one embodiment, the first indication of the starting REs for the first subset of CDM groups and the second indication of starting REs for the second subset of CDM groups comprise a common configuration of starting subcarriers for both the first subset of CDM groups in the first slot and the second subset of CDM groups in the second slot. In one embodiment, the first indication of the starting REs for the first subset of CDM groups comprises a first indication of starting subcarriers of the first subset of CDM groups in the first slot, and the second indication of starting REs comprises a second indication of starting subcarriers of the second subset of CDM groups in the second slot. In one embodiment, the first indication of starting REs and the second indication of starting REs comprise a common configuration of starting subcarriers and starting symbols for both the first subset of CDM groups in the first slot and the second subset of CDM groups in the second slot.

In one embodiment, the method further comprises sending, to the network node, capability information comprising information that indicates that the UE supports CSI-RS resources with more than 32 ports. In one embodiment, the capability information further comprises any one or more of the following information: maximum number of supported CSI-RS ports per CSI-RS resource, specific number of supported CSI-RS ports per CSI-RS resource, maximum number of PRB sets, support of PRB set specific starting subcarriers used for different CDM groups, support of different number of CDM groups in different PRB sets, support of transmitting different CSI-RS ports of the same CSI-RS resource in different slots, maximum number of slots the CSI-RS ports belonging to the same CSI-RS resource can be distributed over, support of slot specific starting symbol configuration for CDM groups in different, and support of slot specific starting subcarriers for CDM groups in different slots.

Corresponding embodiments of a UE are also disclosed. In one embodiment, a UE is adapted to receive, from a network node, a first indication of starting REs for a first subset of CDM groups in a first set of time-frequency resource units and receive, from the network node, a second indication of starting REs for a second subset of CDM groups in a second set of time-frequency resource units. The UE is further adapted to receive a first subset of NZP CSI-RS ports in the first subset of CDM groups, in accordance with the first indication of the starting REs for the first subset of CDM groups in the first set of time-frequency resource units. The UE is further adapted to receive a second subset of NZP CSI-RS ports in the second subset of CDM groups, in accordance with the second indication of the starting REs for the second subset of CDM groups in the second set of time-frequency resource units.

In one embodiment, a UE comprises a communication interface comprising a transmitter and a receiver, and processing circuitry associated with the communication interface. The processing circuitry is configured to cause the UE to receive, from a network node, a first indication of starting REs for a first subset of CDM groups in a first set of time-frequency resource units and receive, from the network node, a second indication of starting REs for a second subset of CDM groups in a second set of time-frequency resource units. The processing circuitry is further configured to cause the UE to receive a first subset of NZP CSI-RS ports in the first subset of CDM groups, in accordance with the first indication of the starting REs for the first subset of CDM groups in the first set of time-frequency resource units. The processing circuitry is further configured to cause the UE to receive a second subset of NZP CSI-RS ports in the second subset of CDM groups, in accordance with the second indication of the starting REs for the second subset of CDM groups in the second set of time-frequency resource units.

Embodiments of a method performed by a network node are also disclosed. In one embodiment, a method performed by a network node comprises sending, to a UE, a first indication of starting REs for a first subset of CDM groups in a first set of time-frequency resource units and sending, to the UE, a second indication of starting REs for a second subset of CDM groups in a second set of time-frequency resource units. The method further comprises transmitting, to the UE, a first subset of NZP CSI-RS ports in the first subset of CDM groups, in accordance with the first indication of the starting REs for the first subset of CDM groups in the first set of time-frequency resource units. The method further comprises transmitting, to the UE, a second subset of NZP CSI-RS ports in the second subset of CDM groups, in accordance with the second indication of the starting REs for the second subset of CDM groups in the second set of time-frequency resource units.

Corresponding embodiments of a network node are also disclosed. In one embodiment, a network node is adapted to send, to a UE, a first indication of starting REs for a first subset of CDM groups in a first set of time-frequency resource units and send, to the UE, a second indication of starting REs for a second subset of CDM groups in a second set of time-frequency resource units. The network node is further adapted to transmit, to the UE, a first subset of NZP CSI-RS ports in the first subset of CDM groups, in accordance with the first indication of the starting REs for the first subset of CDM groups in the first set of time-frequency resource units. The network node is further adapted to transmit, to the UE, a second subset of NZP CSI-RS ports in the second subset of CDM groups, in accordance with the second indication of the starting REs for the second subset of CDM groups in the second set of time-frequency resource units.

In one embodiment, a network node comprises a communication interface and processing circuitry associated with the communication interface. The processing circuitry is configured to cause the network node to send, to a UE, a first indication of starting REs for a first subset of CDM groups in a first set of time-frequency resource units and send, to the UE, a second indication of starting REs for a second subset of CDM groups in a second set of time-frequency resource units. The processing circuitry is further configured to cause the network node to transmit, to the UE, a first subset of NZP CSI-RS ports in the first subset of CDM groups, in accordance with the first indication of the starting REs for the first subset of CDM groups in the first set of time-frequency resource units. The processing circuitry is further configured to cause the network node to transmit, to the UE, a second subset of NZP CSI-RS ports in the second subset of CDM groups, in accordance with the second indication of the starting REs for the second subset of CDM groups in the second set of time-frequency resource units.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of spatial multiplexing in New Radio (NR);

FIG. 2 illustrates an example of a 4×4 (i.e., N₁×N₂,) array with dual-polarized antenna elements (i.e., Nₚ=2);

FIG. 3 shows an example of Channel State Information (CSI) Reference Signal (CSI-RS) Resource Elements (REs) for 12 antenna ports, where 1 RE per Resource Block (RB) per port is shown;

FIGS. 4, 5, and 6 illustrate examples of one embodiment of the present disclosure;

FIGS. 7 and 8 illustrate examples of another embodiment of the present disclosure;

FIG. 9 illustrates the operation of a network node (e.g., a base station such as, e.g., a gNB) and a User Equipment (UE), in accordance with embodiments of the present disclosure;

FIG. 10 shows an example of a communication system in accordance with some embodiments;

FIG. 11 shows a UE in accordance with some embodiments;

FIG. 12 shows a network node in accordance with some embodiments;

FIG. 13 is a block diagram of a host, which may be an embodiment of the host of FIG. 10, in accordance with various aspects described herein;

FIG. 14 is a block diagram illustrating a virtualization environment in which functions implemented by some embodiments may be virtualized; and

FIG. 15 shows a communication diagram of a host communicating via a network node with a UE over a partially wireless connection, in accordance with some embodiments.

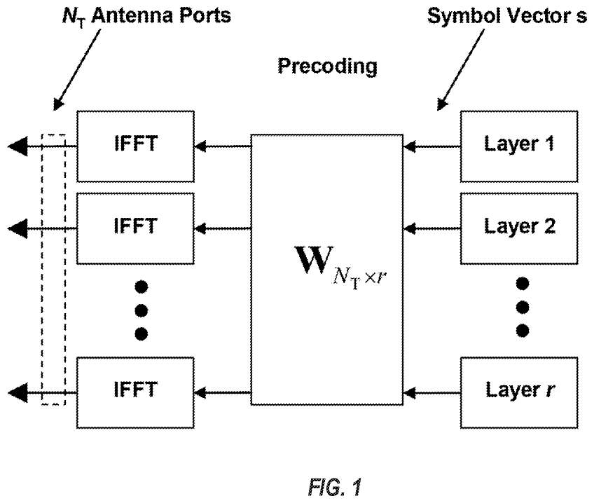

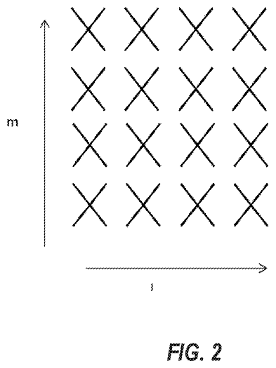

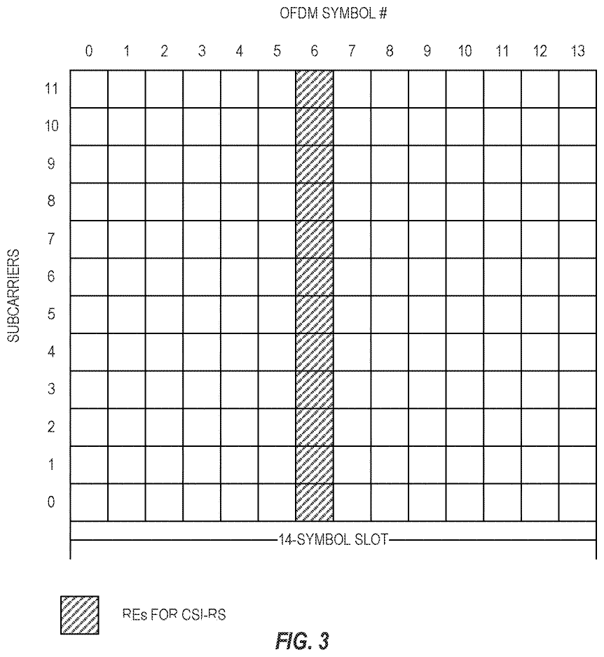

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In 3^{rd} Generation Partnership Project (3GPP) New Radio (NR), the maximum number of supported Non-Zero Power (NZP) Channel State Information (CSI) Reference Signal (CSI-RS) ports in a CSI-RS resource is 32, and all the CSI-RS ports are mapped to a subset of the Resource Elements (REs) in each of the configured Physical Resource Blocks (PRBs) for a CSI-RS resource (i.e., in a given PRB carrying CSI-RS, all the NZP CSI-RS ports are present).

With the advent of large antenna arrays with more transmit chains at the NR base station (gNodeB or gNB), there is a need to support more than 32 CSI-RS ports (e.g., 64 NZP CSI-RS ports or 128 NZP CSI-RS ports) to reap the performance benefits offered by such arrays. However, in order to support more than 32 CSI-RS ports such as 64 NZP CSI-RS ports or 128 NZP CSI-RS ports, it may not be feasible to place all the NZP CSI-RS ports together in a same PRB or a slot. This is because a large number of REs such as 64 or 128 may not always be available in a PRB due to the presence of other channels (e.g., control channels) and signals (e.g., Synchronization Signal (SS)/Physical Broadcast Channel (PBCH) Blocks (SSBs), CSI-RSs, or Tracking Reference Signals (TRSs)). Given these limitations, how to configure and transmit a number of CSI-RS ports that is larger than 32 (e.g., 64 or 128) is an open problem.

Certain aspects of the disclosure and their embodiments may provide solutions to these or other challenges. Systems and methods are disclosed herein that relate to configuration of the number of CSI-RS ports per CSI-RS resource beyond 32 CSI-RS port per CSI-RS resource by allocating different subsets of the CSI-RS ports belonging to one CSI-RS resource to different sets of PRBs and/or slots.

Some example embodiments of the present disclosure are as follows:
1. A method of configuring NZP CSI-RS, the method comprising:
   a. receiving a first indication of starting REs for a first subset of Code Division Multiplexing (CDM) groups in a first subset of time-frequency resource units;
   b. receiving a second indication of starting REs for a second subset of CDM groups in a second subset of time-frequency resource units;
   c. receiving a first subset of NZP CSI-RS ports in the first subset of CDM groups; and
   d. receiving a second subset of NZP CSI-RS ports in the second subset of CDM groups.
2. The method of 1, wherein the first subset of time-frequency resource units is composed of a first subset of PRBs in a slot, and the second subset of time-frequency resource units is composed of a second subset of PRBs mutually exclusive to the first subset of PRBs in the slot.
3. The method of any of 1-2, wherein the first subset of PRBs is the even PRBs and the second subset of PRBs is the odd PRBs.
4. The method of any of 1-3, wherein the first indication of starting REs comprises a first indication of starting subcarriers of the first subset of CDM groups, and the second indication of staring REs comprises a second indication of staring subcarriers of the second subset of CDM groups.
5. The method of 1, wherein the first subset of time-frequency resource units is composed of a plurality of PRBs in a first slot, and the second subset of time-frequency resource units is composed of the plurality of PRBs in a second slot.
6. The method 5, wherein the second slot is the adjacent slot to the first slot.
7. The method of any of 1 and 5-6, wherein the first indication of starting REs comprises a first indication of starting symbols of the first subset of CDM groups, and the second indication of staring REs comprises a second indication of staring symbols of the second subset of CDM groups.
8. The method of any of the above, where the UE indicates in UE capability signaling that is supports CSI-RS resources with more than 32 ports.
9. The method of 8, where the UE capability signaling in addition contains one or more of the following information
   a. Maximum number of supported CSI-RS ports per CSI-RS resource
   b. Specific number of supported CSI-RS ports per CSI-RS resource
   c. Maximum number of PRB sets (as defined in 1)
   d. Support of PRB set specific starting subcarriers used for different CDM groups
   e. Support of different number of CDM groups in different PRB sets
   f. Support of transmitting different CSI-RS ports of the same CSI-RS resource in different slots
   g. Maximum number of slots the CSI-RS ports belonging to the same CSI-RS resource can be distributed over
   h. Support of slot specific starting symbol configuration for CDM groups in different
   i. Support of slot specific starting subcarriers for CDM groups in different slots

Certain embodiments may provide one or more of the following technical advantage(s). Embodiments of the present disclosure introduce a Resource Block (RB) and/or slot specific subcarrier offset of Code Division Multiplexing (CDM) groups that belong to CSI-RS resources. This allows a greater flexibility in configuring such large CSI-RS resource so that it is easier in the deployment to avoid other signals and channels. Embodiments of the proposed solutions may also help reduce CSI-RS overhead when a number of NZP CSI-RS ports per CSI-RS resource that is larger than 32 ports is supported.

### EMBODIMENT 1: PRB SET SPECIFIC STARTING SUBCARRIERS USED FOR DIFFERENT CDM GROUPS

In one embodiment, PRBs configured for a CSI-RS resource are divided into two or more non-overlapping sets of PRBs (or in short sets of “RBs”). Starting subcarriers used for CDM groups for each of the sets of RBs within the CSI-RS resource (e.g., a NZP CSI-RS resource) are signaled per set (e.g., via Radio Resource Control (RRC) configuration) from the gNB to the UE.

In other words, the starting subcarriers used for different CDM groups in different RB sets are independently configured and signaled from the network to the UE. A preferred case is configuring two sets of RBs consisting of odd numbered and even numbered RBs respectively. To simplify the following discussion, two sets are assumed but the embodiments described below for two sets of RBs are extendible to more than two sets of RBs, as will be appreciated by one of ordinary skill in the art.

Let us denote the number of CDM groups corresponding to the CSI-RS ports mapped to the even PRBs as Qₑᵥₑₙ, where each of the CDM groups is mapped to different sets of sub-carriers. Then, the starting subcarriers of the CDM groups in the even PRBs can be denoted as:

$${k}_{0} , {k}_{1} , … , {k}_{{Q}_{even} - 1} .$$

Note that kₘ (m=0, 1, . . . , Qₑᵥₑₙ−1) is the starting subcarrier corresponding to the (m+1)^{th} CDM group corresponding to the CSI-RS ports mapped to the even PRBs. The value of kₘ is with respect to the starting subcarrier within each PRB, hence at most value 11.

Let NED denote the length of the CDM group in the frequency domain. For instance, a CDM group of size 8 having length 2 subcarriers in frequency domain and length 4 symbols in time domain has N_{FD}=2. When N_{FD}=2, then 3GPP specifications restrict the starting subcarrier index kₘ to only have values of 0, 2, 4, 6, 8, or 10 (i.e., the step size of kₘ is N_{FD}).

Similarly, let Q_{odd} denote the number of CDM groups corresponding to the CSI-RS ports mapped to the odd PRBs, where each of the CDM groups is mapped to different sets of sub-carriers. Then, the starting subcarriers of the CDM groups in the odd PRBs can be denoted as:

$${k}_{{Q}_{even}} , {k}_{{Q}_{even} + 1} , … , {k}_{{Q}_{even} + {Q}_{odd} - 1} .$$

kₘ (m=Qₑᵥₑₙ, Qₑᵥₑₙ+1, . . . , Qₑᵥₑₙ+Q_{odd}+1) denotes the starting subcarrier corresponding to the (m−Qₑᵥₑₙ+1)^{th} CDM group corresponding to the CSI-RS ports mapped to the odd PRBs. Hence there are Qₑᵥₑₙ+Q_{odd} CDM groups in total to define all the ports of the CSI-RS resource.

In this embodiment, the gNB separately indicates the values of k₀, k₁, . . . , k_{Q}_{ₑᵥₑₙ}₋1 and the values of k_{Q}_{ₑᵥₑₙ}, k_{Q}_{ₑᵥₑₙ}₊₁, . . . , k_{Q}_{ₑᵥₑₙ}+Q_{odd-1}. per NZP CSI-RS resource to maximize the flexibility.

Let N_{sub,PRB} denote the number of subcarriers per PRB (e.g., N_{sub,PRB}=12), the number of candidate starting sub-carrier positions for a CDM group is

$${N}_{b} = \frac{{N}_{sub , PRB}}{{N}_{FD}} .$$

In one embodiment, the values of k₀, k₁, . . . , k_{Q}_{ₑᵥₑₙ}₋₁ are indicated as a first bitmap b₀, b₁, . . . , b_{N}_{_{b}}₋₁, where the first bitmap is mapped to the values of k₀, k₁, . . . , k_{Q}_{ₑᵥₑₙ}₋₁ as follows:

$${k}_{i - 1} = {N}_{FD} f ( i ) , \qquad i = 1 , 2 , … , {Q}_{even}$$

In the above, f(i) is defined as the bit number of the i^{th} bit, bᵢ, in the bitmap b₀, b₁, . . . , b_{N}_{_{b}}₋₁ set to one. In this embodiment, the values of k_{Q}_{ₑᵥₑₙ}, k_{Q}_{ₑᵥₑₙ}₊₁, . . . , k_{Q}_{ₑᵥₑₙ}_{+Q}_{_{odd}}₋₁ are indicated by a second bitmap b′₀, b′₁, . . . , b′_{N}_{_{b}}₋₁, where the second bitmap is mapped to the values of k_{Q}_{ₑᵥₑₙ}, k_{Q}_{ₑᵥₑₙ}₊₁, . . . , k_{Q}_{ₑᵥₑₙ}_{+Q}_{_{odd}}₋₁ as follows:

$${k}_{i + {Q}_{even} - 1} = {N}_{FD} {f}^{′} ( i ) , \qquad i = 1 , 2 , … , {Q}_{odd}$$

In the above, f′(i) is defined as the bit number of the i^{th} bit, b′ᵢ, in the bitmap b′₀, b′₁, . . . , b′_{N}_{_{b}}₋₁ set to one.

In an alternative embodiment, k₀, k₁, . . . , k_{Q}_{ₑᵥₑₙ}₋₁ specific to even PRBs and k_{Q}_{ₑᵥₑₙ}, k_{Q}_{ₑᵥₑₙ}₊₁, k_{Q}_{ₑᵥₑₙ}_{+Q}_{_{odd}}₋₁ specific to odd PRBs may be signaled by the gNB to the UE as a set or list of integer values or enumerated values. In one variant of this alternative embodiment, the subcarrier indices may be signaled by the gNB to the UE as a single set or list of integer or enumerated values, where one half of the integers in the set or list correspond to the even PRBs and the other half of the integers in the set or list correspond to the odd PRBs.

In another alternative embodiment, the first bitmap b₀, b₁, . . . , b_{N}_{_{b}}₋₁ and the second bitmap b′₀, b′₁, . . . , b′_{N}_{_{b}}₋₁ may be concatenated and signaled as a single bitmap (e.g., a single bitmap [b_{N}_{_{b}}₋₁ . . . b₁ b₀ b′_{N}_{_{b}}₋₁ . . . b′₁ b′₀]) by the gNB to the UE, where one half of the bits in the bitmap correspond to the even PRBs and the other half of the bits in the bitmap correspond to the odd PRBs.

In one embodiment, the number of CDM groups in the even PRBs is restricted (e.g., by specification) to be the same as the number of CDM groups in the odd PRBs (i.e., Qₑᵥₑₙ=Q_{odd}). In this case, a single value Q is configured from the NW to the UE and it indicates the number of CDM groups used in all the sets (which is then restricted to be the same). In another embodiment, the value of Q is specified as part of 3GPP specifications.

In an alternative embodiment, the number of CDM groups in the even PRBs is different from the number of CDM groups in the odd PRBs (i.e., Qₑᵥₑₙ≠Q_{odd}). In this alternative embodiment, one or both of the number of CDM groups Qₑᵥₑₙ and Q_{odd} may be additionally signaled by the gNB to the UE.

In an example embodiment, to signal the PRB set specific bitmaps, the CSI-RS-ResourceMapping information element in 3GPP TS 38.331 V17.3.0 is modified as follows. In the example embodiment below, the field frequencyDomainAllocation→other configures the bitmap specific to a first set of PRBs (e.g., even PRBs), and the newly introduced field frequentyDomainAllocation2 configures the bitmap specific to a second set of PRBs (e.g., odd PRBs). Although the bitmap size is shown to be 6 in the below example embodiment, the example is non-limiting and hence other bitmap sizes may be signaled depending on the size of the CDM group as discussed in further embodiments below.

CSI-RS-ResourceMapping information element

-- ASN1START
-- TAG-CSI-RS-RESOURCEMAPPING-START

| | |
|---|---|
| CSI-RS-ResourceMapping :: = | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

```
    },
  ...
  [[
```

| | |
|---|---|
| frequencyDomainAllocation2-rxx | BIT STRING (SIZE (6)) |

```
  ]]
    ...
}
-- TAG-CSI-RS-RESOURCEMAPPING-STOP
-- ASN1STOP
```

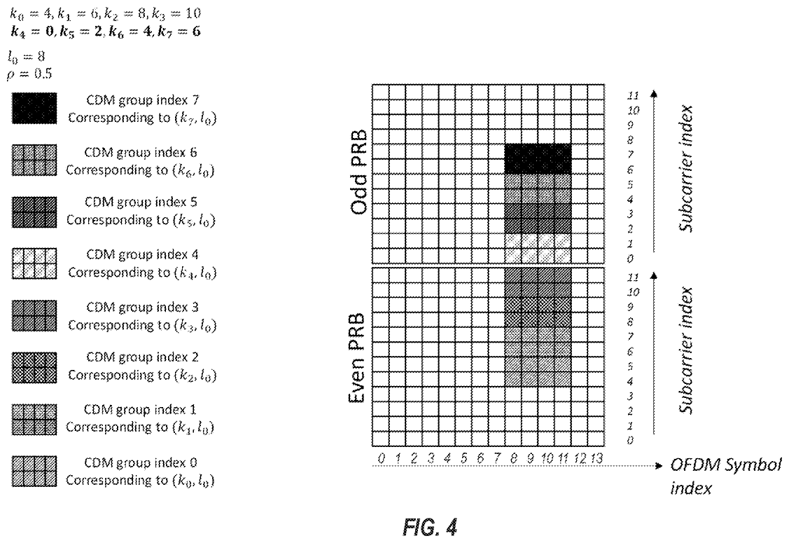

A first example of this embodiment is shown in FIG. 4 with 64-port NZP CSI-RS using CDM-8 (i.e., CDM groups with size 8). Each CDM group has length N_{FD}=2 subcarriers in the frequency domain, and length 4 symbols in the time domain. The density of CSI-RS is configured as ρ=0.5 CSI-RS ports/PRB, and all CDM groups have starting symbol l₀=8 in time domain.

In an alternative embodiment, a new density parameter ρ′ is defined as ports/PRB set (or the definition of the legacy density parameter is revised in specifications); hence, in this example, ρ′=1 CSI-RS ports/PRB set, meaning that only RB of a set is counted towards the density and since in this example, within a set, the density is ρ′=1.

In FIG. 4, Qₑᵥₑₙ=Q_{odd}=4. In this example, the first and the second bitmaps are signaled as follows:

$$[ {b}_{5} {b}_{4} {b}_{3} {b}_{2} {b}_{1} {b}_{0} ] = [ 111100 ]$$

$$[ {b}_{5}^{′} {b}_{4}^{′} {b}_{3}^{′} {b}_{2}^{′} {b}_{1}^{′} {b}_{0}^{′} ] = [ 001111 ]$$

As described above, the first bitmap is mapped to [k₀=4, k₁=6, k₂=8, k₃=10], and the second bitmap is mapped to [k₄=0, k₅=2, k₆=4, k₇=6]. Hence, the starting subcarriers of the CDM groups are given as follows:
Starting subcarrier of CDM group 0 in even PRBs is k₀=4
Starting subcarrier of CDM group 1 in even PRBs is k₁=6
Starting subcarrier of CDM group 2 in even PRBs is k₂=8
Starting subcarrier of CDM group 3 in even PRBs is k₃=10
Starting subcarrier of CDM group 4 in odd PRBs is k₄=0
Starting subcarrier of CDM group 5 in odd PRBs is k₅=2
Starting subcarrier of CDM group 6 in odd PRBs is k₆=4
Starting subcarrier of CDM group 7 in odd PRBs is k₇=6

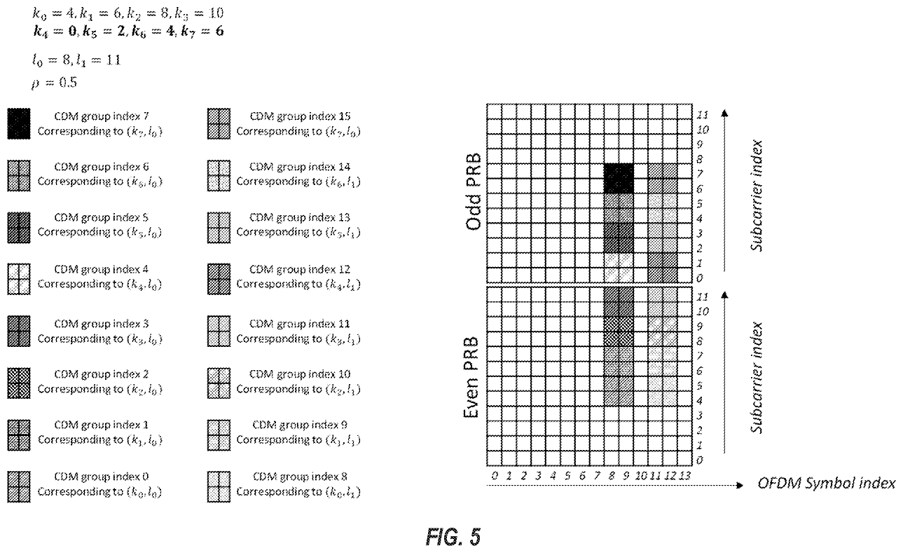

A second example of this embodiment is shown in FIG. 5 with 64-port NZP CSI-RS using CDM-4 (i.e., CDM groups with size 4). Each CDM group has length N_{FD}=2 subcarriers in the frequency domain, and length 2 symbols in the time domain. The density of CSI-RS is configured as ρ=0.5 CSI-RS ports/PRB (or ρ′=1) with the alternative definition mentioned above. CDM groups 0-7 have starting symbol l₀=8 in time domain, and CDM groups 8-15 have starting symbol/1=11 in time domain. Note that in this example embodiment, the two starting symbols l₀ and l₁ are applicable to both even PRBs and odd PRBs.

In FIG. 5, Qₑᵥₑₙ=Q_{odd}=8. In this example, the first and the second bitmaps are signaled as follows:

$$[ {b}_{5} {b}_{4} {b}_{3} {b}_{2} {b}_{1} {b}_{0} ] = [ 111100 ]$$

$$[ {b}_{5}^{′} {b}_{4}^{′} {b}_{3}^{′} {b}_{2}^{′} {b}_{1}^{′} {b}_{0}^{′} ] = [ 001111 ]$$

As described above, the first bitmap is mapped to [k₀=4, k₁=6, k₂=8, k₃=10], and the second bitmap is mapped to [k₄=0, k₅=2, k₆=4, k₇=6]. Hence, the starting subcarriers of the CDM groups are given as follows:
CDM group 0 in even PRBs starts at subcarrier k₀=4 and symbol l₀=8
CDM group 1 in even PRBs starts at subcarrier k₁=6 and symbol l₀=8
CDM group 2 in even PRBs starts at subcarrier k₂=8 and symbol l₀=8
CDM group 3 in even PRBs starts at subcarrier k₃=10 and symbol l₀=8
CDM group 4 in odd PRBs starts at subcarrier k₄=0 and symbol l₀=8
CDM group 5 in odd PRBs starts at subcarrier k₅=2 and symbol l₀=8
CDM group 6 in odd PRBs starts at subcarrier k₆=4 and symbol l₀=8
CDM group 7 in odd PRBs starts at subcarrier k₇=6 and symbol l₀=8
CDM group 8 in even PRBs starts at subcarrier k₀=4 and symbol l₁=11
CDM group 9 in even PRBs starts at subcarrier k₁=6 and symbol l₁=11
CDM group 10 in even PRBs starts at subcarrier k₂=8 and symbol l₁=11
CDM group 11 in even PRBs starts at subcarrier k₃=10 and symbol l₁=11
CDM group 12 in odd PRBs starts at subcarrier k₄=0 and symbol l₁=11
CDM group 13 in odd PRBs starts at subcarrier k₅=2 and symbol l₁=11
CDM group 14 in odd PRBs starts at subcarrier k₆=4 and symbol l₁=11
CDM group 15 in odd PRBs starts at subcarrier k₇=6 and symbol l₁=11

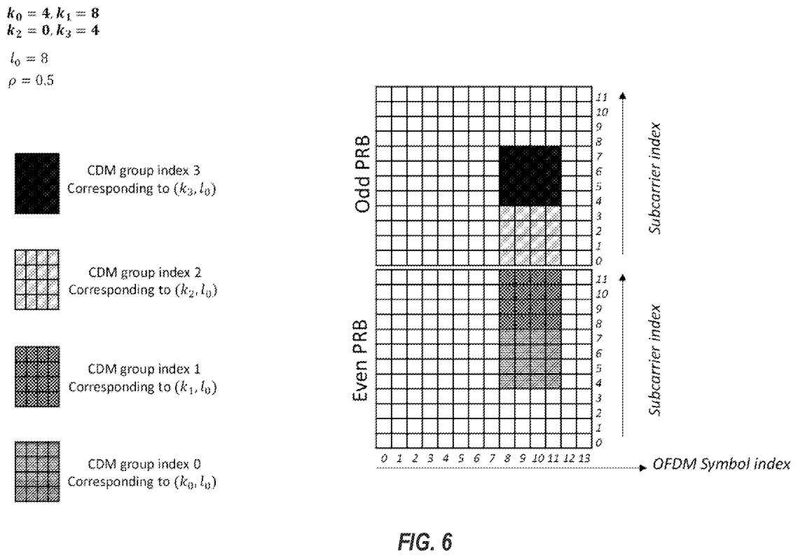

A third example of this embodiment is shown in FIG. 6 with 64-port NZP CSI-RS using CDM-16 (i.e., CDM groups with size 16). Each CDM group has N_{FD}=4 subcarriers in the frequency domain, and 4 symbols in the time domain. The density of CSI-RS is configured as ρ=0.5 CSI-RS ports/PRB, and all CDM groups have starting symbol l₀=8 in time domain.

In FIG. 6, Qₑᵥₑₙ=Q_{odd}=2. In this example, the first and the second bitmaps are signaled as follows:

$$[ {b}_{2} {b}_{1} {b}_{0} ] = [ 110 ]$$

$$[ {b}_{2}^{′} {b}_{1}^{′} {b}_{0}^{′} ] = [ 011 ]$$

As described above, the first bitmap is mapped to [k₀=4, k₁=8], and the second bitmap is mapped to [k₂=0, k₃=4]. Hence, the starting subcarriers of the CDM groups are given as follows:
Starting subcarrier of CDM group 0 in even PRBs is k₀=4
Starting subcarrier of CDM group 1 in even PRBs is k₁=6
Starting subcarrier of CDM group 2 in odd PRBs is k₂=0.
Starting subcarrier of CDM group 3 in odd PRBs is k₃=4

In another embodiment, a common configuration on starting subcarriers may be used for CDM groups in both even and odd numbered PRBs, where some CSI-RS ports are mapped to even numbered PRBs and the remaining CSI-RS ports are mapped to odd numbered PRBs.

In a further embodiment, the number of CDM groups in even numbered PRBs may be different from the number of CDM groups in odd numbered PRBs and the starting sub-carriers may be jointly configured for all CDM groups in two consecutive PRBs, the sub-carriers within a pair of even and odd PRBs are indexed continuously starting from 0 to 23.

Although the above embodiments cover the starting subcarriers of different CDM groups in different PRB sets being signaled independently as part of a single CSI-RS resource, in some alternative embodiments, the embodiments covered above may also be extended to the case where the starting subcarriers of different CDM groups in a first PRB set is signaled as part of a first NZP CSI-RS resource and the staring subcarriers of different CDM groups in a second PRB set is signaled as part of a second NZP CSI-RS resource. In these alternative embodiments, the first NZP CSI-RS resource and the second NZP CSI-RS resources are linked to form an overall NZP CSI-RS resource that has more than 32 NZP CSI-RS ports. The linking of the two NZP CSI-RS resources may be achieved by configuring a linking identifier with the same value in the two NZP CSI-RS resources or by configuring a list consisting of the resource identifiers of the two NZP CSI-RS resources.

Although 64 ports are used in the examples above, the number of CSI-RS ports can be more than 64 ports such as 96 or 128 ports.

### EMBODIMENT 2: SLOT SPECIFIC STARTING SYMBOLS USED FOR DIFFERENT CDM GROUPS (I.E., MULTI-SLOT CSI-RS)

In the previous discussions, all CSI-RS antenna ports of a CSI-RS resource are mapped to a same time slot. In some scenarios, when there is a large number of CSI-RS antenna ports, mapping all CSI-RS ports to a same slot may be difficult due to presence of other signals or channels. In this case, it may be easier to map the CSI-RS ports in multiple time slots, where different CSI-RS ports are mapped to different time slots.

In one embodiment, a common sub-carrier configuration (i.e., the subcarriers occupied by CDM groups) may be used for CDM groups in different slots while a slot specific starting symbol configuration may be used for CDM groups in different slots.

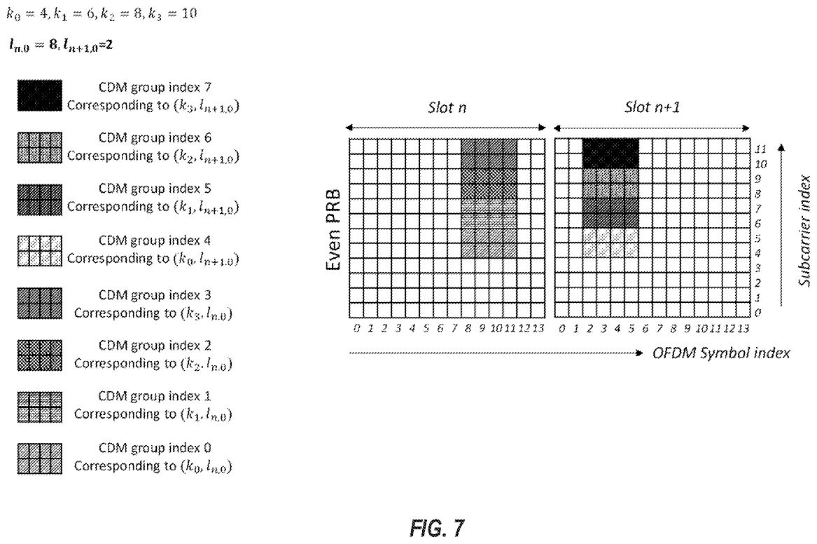

An example is shown in FIG. 7, where 64 CSI-RS ports of a CSI-RS resource are mapped to two consecutive time slots each with 32 ports in 4 CDM groups. In this example, the same sub-carriers are allocated to CDM groups in both slots, i.e., [k₀=k₄=4, k₁=k₅=6, k₂=k₆=8, k₃=k₇=10], while different starting symbols are allocated in the two slots, i.e., symbol 8 in slot n and symbol 2 in slot n+1. The density of CSI-RS can be either ρ=1 or ρ=0.5. For this example, there are one set of common sub-carrier configurations for CDM groups for both slots and two sets of slot specific starting symbol configurations for CDM groups. In FIG. 7, the following notations are used:
L_{n,0} is the configured starting symbol for CDM groups in slot n.
L_{n+1,0} is the configured starting symbol for CDM groups in slot n+1

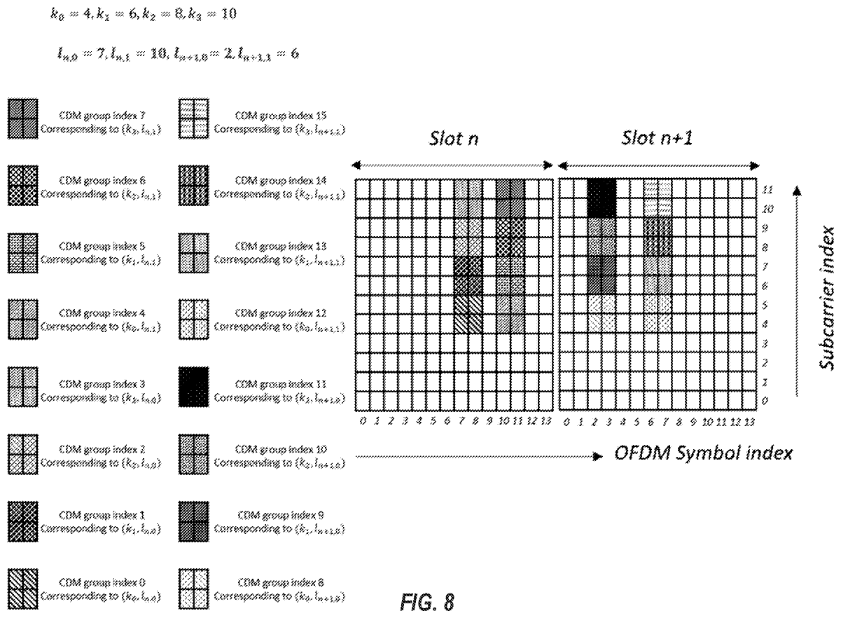

Another example is shown in FIG. 8, where non-consecutive symbols are configured for CDM groups in both slots. Different starting symbols are configured in the two slots and also, different time gaps between CDM groups within each slot are configured in the two slots. In FIG. 8, the following notations are used:
L_{n,0} and L_{n,1} are the configured starting symbols for CDM groups in slot n.
L_{n+1,0} and L_{n+1,1} are the configured starting symbols for CDM groups in slot n+1

In another embodiment, both starting sub-carriers and starting symbols for the CDM groups may be independently configured for each slot.

In a further embodiment, a common configuration on starting sub-carriers and starting symbols for the CDM groups may be used for all the slots configured for a CSI-RS resource.

In an example embodiment, to signal the slot specific bitmaps, the CSI-RS-ResourceMapping information element in 3GPP TS 38.331 V17.3.0 is modified as follows. In the example embodiment below, the fields firstOFDMSymbolInTimeDomain (denoted by L_{n,0} in above embodiments) and firstOFDMSymbolInTimeDomain2 (denoted by L_{n,1} in above embodiments) configures the staring symbols of CDM groups in a first slot. The fields firstOFDMSymbolInTimeDomain3 (denoted by L_{n+1,0} in above embodiments) and firstOFDMSymbolInTimeDomain4 (denoted by L_{n+1,1} in above embodiments) configures the staring symbols of CDM groups in a second slot.

CSI-RS-ResourceMapping information element

-- ASN1START
-- TAG-CSI-RS-RESOURCEMAPPING-START

| | |
|---|---|
| CSI-RS-ResourceMapping :: = | SEQUENCE { |

...

| | |
|---|---|
| firstOFDMSymbolInTimeDomain | INTEGER (0..13), |
| firstOFDMSymbolInTimeDomain2 | INTEGER (2..12) |

```
  ...
  [[
```

| | |
|---|---|
| firstOFDMSymbolInTimeDomain3-rxx | INTEGER (0..13), |
| firstOFDMSymbolInTimeDomain4-rxx | INTEGER (2..12) |

```
  ]]
    ...
}
-- TAG-CSI-RS-RESOURCEMAPPING-STOP
-- ASN1STOP
```

Although the above embodiments cover the starting symbols of different CDM groups in different slots being signaled independently as part of a single CSI-RS resource, in some alternative embodiments, the embodiments covered above may also be extended to the case where the starting symbols of different CDM groups in a first slot are signaled as part of a first NZP CSI-RS resource and the staring symbols of different CDM groups in a second slot are signaled as part of a second NZP CSI-RS resource. In these alternative embodiments, the first NZP CSI-RS resource and the second NZP CSI-RS resources are linked to form an overall NZP CSI-RS resource that has more than 32 NZP CSI-RS ports. The linking of the two NZP CSI-RS resources may be achieved by configuring a linking identifier with the same value in the two NZP CSI-RS resources or by configuring a list consisting of the resource identifiers of the two NZP CSI-RS resources.

### UE Capability Signaling

In one embodiment, the UE signals, during UE capability signaling, support for more than 32 CSI-RS ports per CSI-RS resource or over multiple linked CSI-RS resources. In one embodiment, the UE capability signaling indicating support for more than 32 CSI-RS ports per CSI-RS resource or over multiple linked CSI-RS resources contains in addition one or more of the following information:
Maximum number of supported CSI-RS ports per CSI-RS resource
   E.g. if the UE indicates support of maximum 128 CSI-RS ports per CSI-RS resource, the UE supports all number of CSI-RS ports included in the NR specification up to that maximum number of CSI-RS ports
      E.g. if the NR specification supports CSI-RS ports 64,96,128, and the UE indicates support of maximum 128 CSI-RS ports per CSI-RS resource, then the UE will also support 64 and 96 CSI-RS ports per CSI-RS resource
Specific number of supported CSI-RS ports per CSI-RS resource
   E.g. the UE can indicate support of one or more of X candidate number of CSI-RS ports
      E.g. the UE might indicate support of 64 and 128 CSI-RS ports per CSI-RS resource, but not indicate support of 96 CSI_RS ports per CSI-RS resource
Maximum number of PRB sets (as defined in Embodiment 1)
   E.g. the UE might indicate that it supports up to 1, 2, 3, 4 or more PRB sets
      E.g. if the UE indicates support maximum 2 PRB sets, the UE CSI-RS ports of an CSI-RS resource can be divided in to every second PRB (i.e. even and odd PRBs). If the UE indicates support maximum 4 PRB sets, the UE CSI-RS ports of an CSI-RS resource can be divided in to every fourth PRB (i.e., 4n,4n+1,4n+2,4n+3 PRBs)
Support of PRB set specific starting subcarriers used for different CDM groups
   i.e. where the starting sub-carrier for different CDM groups can be different for different PRB sets
Support of different number of CDM groups in different PRB sets
   E.g. a first PRB set might consist of 2 CDM groups and a second PRB set might consist of 6 CDM groups
Support of transmitting different CSI-RS ports of the same CSI-RS resource in different slots
   E.g. the first 32 CSI-RS ports of a 64-port CSI-RS resource is transmitted in slot n and the remaining 32 CSI-RS ports are transmitted in slot n+X, where X can be 1 or larger than 1
      UE can indicate maximum supported value of X or X can be defined in specification to for example be 1 (i.e., only consecutive slots are supported)
Maximum number of slots the CSI-RS ports belonging to the same CSI-RS resource can be distributed over
   E.g. the CSI-RS ports belonging to the same CSI-RS resource can be distributed over maximum Y consecutive (and/or non-consecutive) slots, where Y, e.g., can be 1,2,3,4 etc.
Support of slot specific starting symbol configuration for CDM groups in different slots
   E.g. a first set of CSI-RS ports belonging to a CSI-RS resource transmitted in a first slot has a first start symbol in that slot, and a second set of CSI-RS ports belonging to the same CSI-RS resource transmitted in a second slot has a second start symbol in that slot, and where the first and second start symbol can be the same or different
Support of slot specific starting subcarriers for CDM groups in different slots
   E.g. a first set of CSI-RS ports belonging to a CSI-RS resource transmitted in a first set of CDM groups in a first slot has a first set of starting sub-carriers, and a second set of CSI-RS ports belonging to the same CSI-RS resource transmitted in a second set of CDM groups in a second slot has a second set of starting sub-carriers, and where the first set of starting sub-carriers and the second set of start sub-carriers can be the same or different

### Further Details

It should be noted that the embodiments described above focus on examples in which the embodiments are implemented in a NR network and, as such, 3GPP NR terminology is oftentimes used. However, the embodiments described herein are not limited to 3GPP NR and may be used in other similar types of wireless networks such as, e.g., a 6th Generation (6G) network.

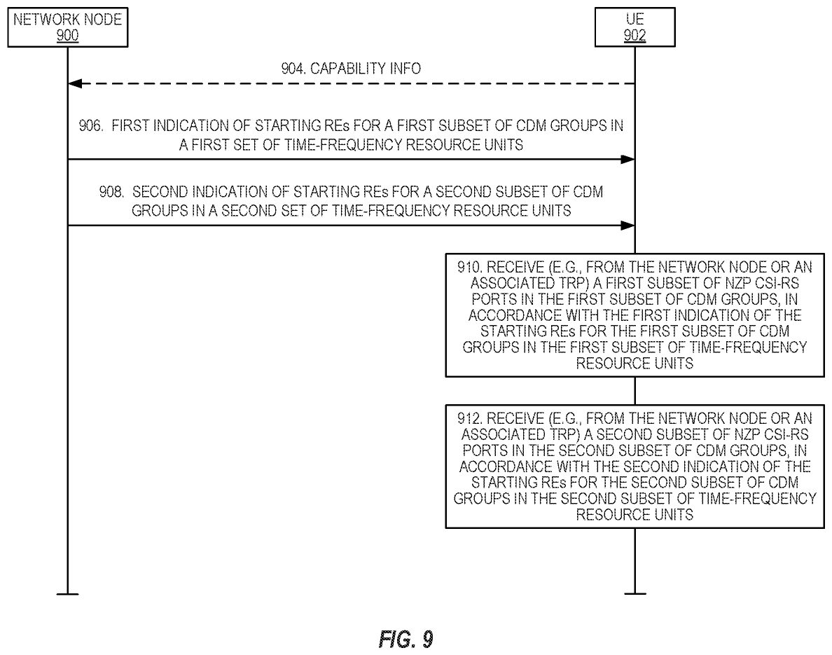

FIG. 9 illustrates the operation of a network node 900 (e.g., a base station such as, e.g., a gNB) and a UE 902, in accordance with at least some of the embodiments described above. Note that the procedure of FIG. 9 may include any one or more of the illustrated steps. Further, while the steps are illustrated in a particular order, the steps may be performed in any order. As illustrated, the UE 902 optionally sends capability information to the network node 900 that indicates that the UE 900 supports more than 32 CSI-RS ports per CSI-RS resource or over multiple linked CSI-RS resources, as described above (step 904). Further details regarding this capability signaling are described above and equally applicable here.

The network node 900 sends, and the UE 902 receives, a first indication of starting REs for a first subset of CDM groups in a first set of time-frequency resource units (step 906). The network node 900 sends, and the UE 902 receives, a second indication of starting REs for a second subset of CDM groups in a second set of time-frequency resource units (step 908). The UE 902 receives (e.g., from the network node or an associated Transmission and Reception Point (TRP)) a first subset of NZP CSI-RS ports in the first subset of CDM groups, in accordance with the first indication of the starting REs for the first subset of CDM groups in the first subset of time-frequency resource units (step 910). The UE receives a second subset of NZP CSI-RS ports in the second subset of CDM groups, in accordance with the second indication of the starting REs for the second subset of CDM groups in the second subset of time-frequency resource units (step 912). Note that further details regarding the steps of FIG. 9 are described in the preceding subsections and are applicable here. For example, various embodiments are described above relating to the first and second indications and the details of those embodiments are equally applicable here.

In one embodiment, the first set of time-frequency resource units is a first subset of time-frequency resource units configured for a NZP CSI-RS resource, and the second set of time-frequency resource units is a second subset of time-frequency resource units configured for the NZP CSI-RS resource. In another embodiment, the first set of time-frequency resource units is a first subset of time-frequency resource units configured for a first NZP CSI-RS resource, and the second set of time-frequency resource units is a second subset of time-frequency resource units configured for a second NZP CSI-RS resource. In one embodiment, the first NZP CSI-RS resource and the second NZP CSI-RS resource are linked to form an overall CSI-RS resource.

As described above, in one embodiment, the first subset of time-frequency resource units comprises a first subset of PRBs in a slot, and the second subset of time-frequency resource units comprises a second subset of PRBs in the slot, wherein the first subset of PRBs in the slot is mutually exclusive to (i.e., does not overlap with) the second subset of PRBs in the slot. In one embodiment, the first subset of PRBs is the even PRBs and the second subset of PRBs is the odd PRBs.

In one embodiment, the first indication of the starting REs for the first subset of CDM groups in the first subset of time-frequency resource units comprises a first indication of starting subcarriers of the first subset of CDM groups in the first subset of time-frequency resource units, and the second indication of starting REs for the second subset of CDM groups in the second subset of time-frequency resource units comprises a second indication of staring subcarriers of the second subset of CDM groups in the second subset of time-frequency resource units.

In one embodiment, the number of CDM groups in the first subset of CDM groups is the same as the number of CDM group in the second subset of CDM groups. In another embodiment, the number of CDM groups in the first subset of CDM groups is different than the number of CDM group in the second subset of CDM groups.

In one embodiment, the first indication and the second indication are separate bitmaps. In another embodiment, the first indication and the second indication concatenated into a single bitmap. In another embodiment, the first indication and the second indication are each a set or list of integer or enumerated values. In another embodiment, the first indication and the second indication are a common configuration for both the first subset of CDM groups in the first subset of time-frequency resource units and the second subset of CDM groups in the second subset of time-frequency resource units.

In one embodiment, the first subset of time-frequency resource units comprises a plurality of PRBs in a first slot, and the second subset of time-frequency resource units comprises a plurality of PRBs in a second slot. In one embodiment, the second slot is adjacent to the first slot. In one embodiment, the first indication of starting REs comprises a first indication of starting symbols of the first subset of CDM groups, and the second indication of starting REs comprises a second indication of staring symbols of the second subset of CDM groups.

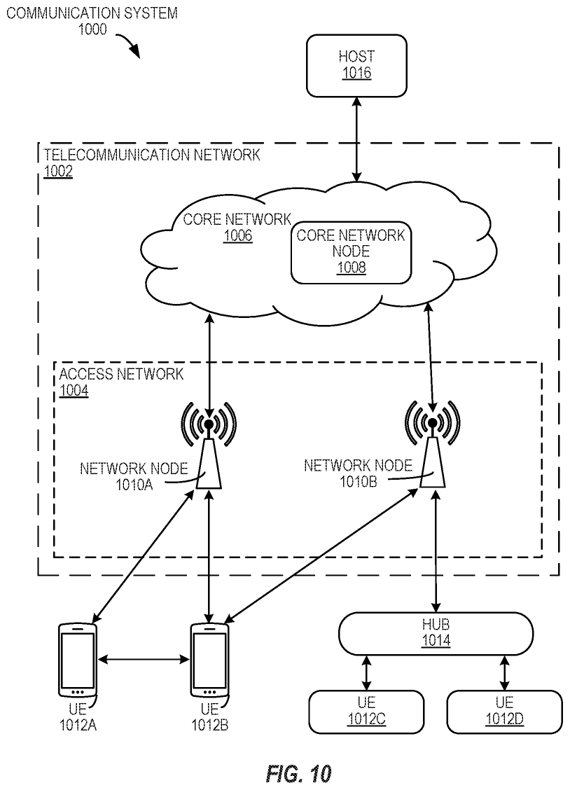

FIG. 10 shows an example of a communication system 1000 in accordance with some embodiments.

In the example, the communication system 1000 includes a telecommunication network 1002 that includes an access network 1004, such as a Radio Access Network (RAN), and a core network 1006, which includes one or more core network nodes 1008. The access network 1004 includes one or more access network nodes, such as network nodes 1010A and 1010B (one or more of which may be generally referred to as network nodes 1010), or any other similar Third Generation Partnership Project (3GPP) access node or non-3GPP Access Point (AP). The network nodes 1010 facilitate direct or indirect connection of User Equipment (UE), such as by connecting UEs 1012A, 1012B, 1012C, and 1012D (one or more of which may be generally referred to as UEs 1012) to the core network 1006 over one or more wireless connections. Note that the functionality of the network node (e.g., network node 900) described above may be implemented in any one or more of the network nodes 1010, and the functionality of the UE (e.g., UE 902) described above may be implemented in any one or more of the UEs 1012.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system 1000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1002 is a cellular network that implements 3GPP standardized features. Accordingly, the telecommunication network 1002 may support network slicing to provide different logical networks to different devices that are connected to the telecommunication network 1002. For example, the telecommunication network 1002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1014 communicates with the access network 1004 to facilitate indirect communication between one or more UEs (e.g., UE 1012C and/or 1012D) and network nodes (e.g., network node 1010B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a Virtual Reality (VR) headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to a Machine-to-Machine (M2M) service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010B. In other embodiments, the hub 1014 may be a non-dedicated hub—that is, a device which is capable of operating to route communications between the UEs and the network node 1010B, but which is additionally capable of operating as a communication start and/or end point for certain data channels.

FIG. 11 shows a UE 1100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1102 may include multiple Central Processing Units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging the power source 1108. Power circuitry may perform any formatting, converting, or other modification to the power from the power source 1108 to make the power suitable for the respective components of the UE 1100 to which power is supplied.

The memory 1110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1110 may allow the UE 1100 to access instructions, application programs, and the like stored on transitory or non-transitory memory media, to off-load data, or to upload data. An article of manufacture, such as one utilizing a communication system, may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., the antenna 1122) and may share circuit components, software, or firmware, or alternatively be implemented separately.

In the illustrated embodiment, communication functions of the communication interface 1112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1112, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

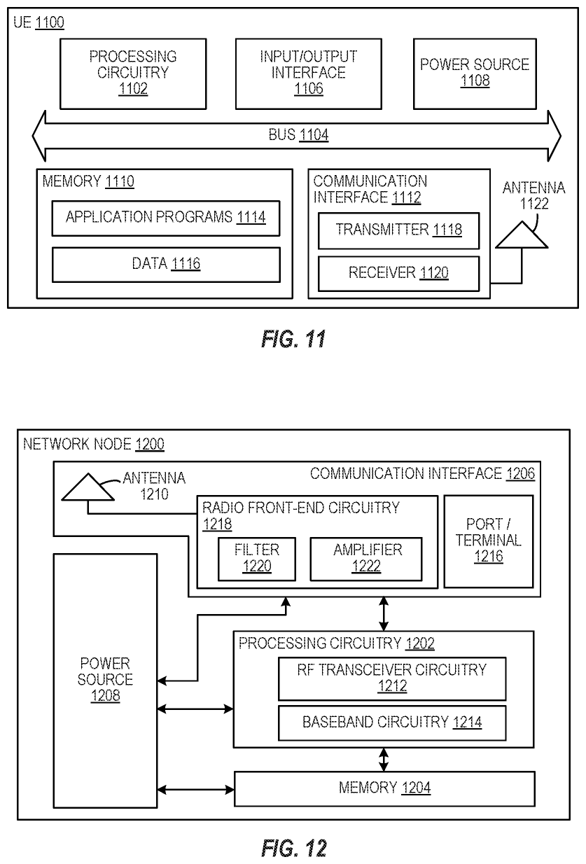

FIG. 12 shows a network node 1200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, memory 1204, a communication interface 1206, and a power source 1208. The network node 1200 may be composed of multiple physically separate components (e.g., a Node B component and an RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1200 may be configured to support multiple RATs. In such embodiments, some components may be duplicated (e.g., separate memory 1204 for different RATs) and some components may be reused (e.g., an antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1200.

The processing circuitry 1202 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1200 components, such as the memory 1204, to provide network node 1200 functionality.

In some embodiments, the processing circuitry 1202 includes a System on a Chip (SOC). In some embodiments, the processing circuitry 1202 includes one or more of Radio Frequency (RF) transceiver circuitry 1212 and baseband processing circuitry 1214. In some embodiments, the RF transceiver circuitry 1212 and the baseband processing circuitry 1214 may be on separate chips (or sets of chips), boards, or units, such as radio units and digital units. In alternative embodiments, part or all of the RF transceiver circuitry 1212 and the baseband processing circuitry 1214 may be on the same chip or set of chips, boards, or units.

The memory 1204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and the memory 1204 are integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. The radio front-end circuitry 1218 comprises filters 1220 and amplifiers 1222. The radio front-end circuitry 1218 may be connected to the antenna 1210 and the processing circuitry 1202. The radio front-end circuitry 1218 may be configured to condition signals communicated between the antenna 1210 and the processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of the filters 1220 and/or the amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface 1206 may comprise different components and/or different combinations of components.

In certain alternative embodiments, the network node 1200 does not include separate radio front-end circuitry 1218; instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes the one or more ports or terminals 1216, the radio front-end circuitry 1218, and the RF transceiver circuitry 1212 as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, the communication interface 1206, and/or the processing circuitry 1202 may be configured to perform any receiving operations and/or certain obtaining operations described herein as being performed by the network node 1200. Any information, data, and/or signals may be received from a UE, another network node, and/or any other network equipment. Similarly, the antenna 1210, the communication interface 1206, and/or the processing circuitry 1202 may be configured to perform any transmitting operations described herein as being performed by the network node 1200. Any information, data, and/or signals may be transmitted to a UE, another network node, and/or any other network equipment.

The power source 1208 provides power to the various components of the network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid or an electricity outlet) via input circuitry or an interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

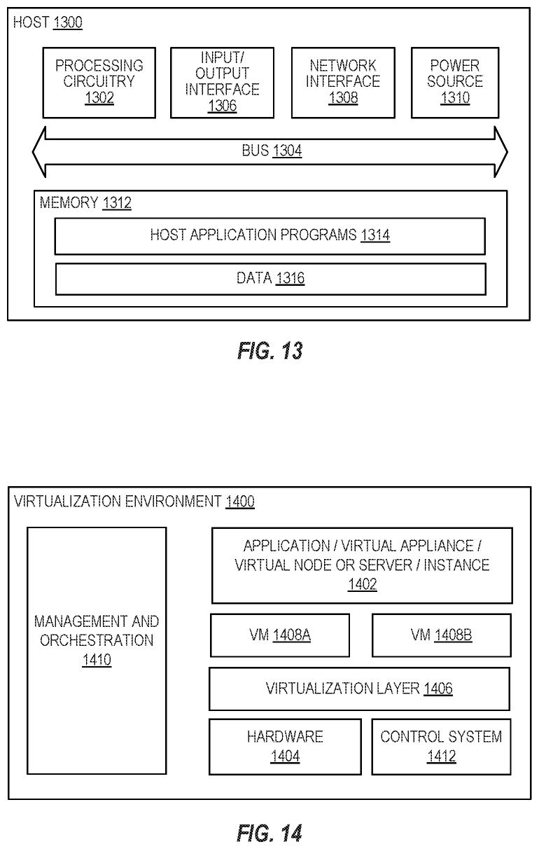

FIG. 13 is a block diagram of a host 1300, which may be an embodiment of the host 1016 of FIG. 10, in accordance with various aspects described herein. As used herein, the host 1300 may be or comprise various combinations of hardware and/or software including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and memory 1312. Other components may be included in other embodiments. Features of these components may be substantially similar to those described with respect to the devices of previous figures, such as FIGS. 11 and 12, such that the descriptions thereof are generally applicable to the corresponding components of the host 1300.

The memory 1312 may include one or more computer programs including one or more host application programs 1314 and data 1316, which may include user data, e.g. data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for Over-The-Top (OTT) services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or VM Monitors (VMMs)), provide VMs 1408A and 1408B (one or more of which may be generally referred to as VMs 1408), and/or perform any of the functions, features, and/or benefits described in relation with some embodiments described herein. The virtualization layer 1406 may present a virtual operating platform that appears like networking hardware to the VMs 1408.

The VMs 1408 comprise virtual processing, virtual memory, virtual networking, or interface and virtual storage, and may be run by a corresponding virtualization layer 1406. Different embodiments of the instance of a virtual appliance 1402 may be implemented on one or more of the VMs 1408, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1408 may be a software implementation of a physical machine that runs programs as if they were executing on a physical, non-virtualized machine. Each of the VMs 1408, and that part of the hardware 1404 that executes that VM, be it hardware dedicated to that VM and/or hardware shared by that VM with others of the VMs 1408, forms separate virtual network elements. Still in the context of NFV, a virtual network function is responsible for handling specific network functions that run in one or more VMs 1408 on top of the hardware 1404 and corresponds to the application 1402.

The hardware 1404 may be implemented in a standalone network node with generic or specific components. The hardware 1404 may implement some functions via virtualization. Alternatively, the hardware 1404 may be part of a larger cluster of hardware (e.g., such as in a data center or CPE) where many hardware nodes work together and are managed via management and orchestration 1410, which, among others, oversees lifecycle management of the applications 1402. In some embodiments, the hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1412 which may alternatively be used for communication between hardware nodes and radio units.

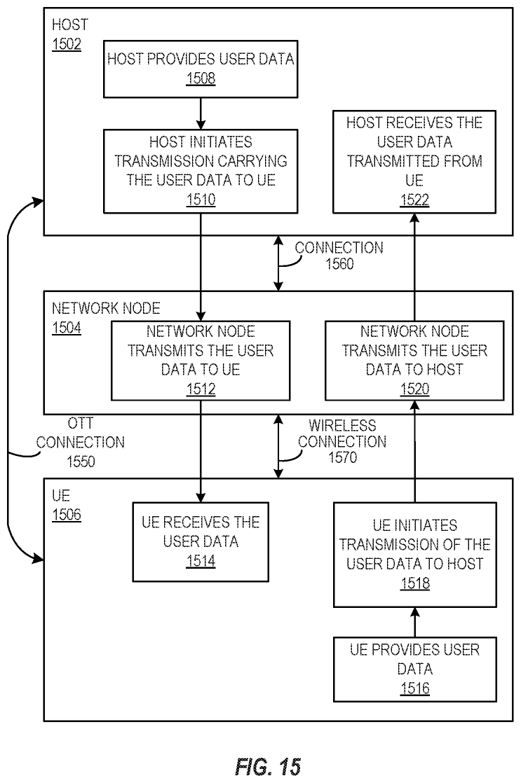

FIG. 15 shows a communication diagram of a host 1502 communicating via a network node 1504 with a UE 1506 over a partially wireless connection in accordance with some embodiments. Example implementations, in accordance with various embodiments, of the UE (such as the UE 1012A of FIG. 10 and/or the UE 1100 of FIG. 11), the network node (such as the network node 1010A of FIG. 10 and/or the network node 1200 of FIG. 12), and the host (such as the host 1016 of FIG. 10 and/or the host 1300 of FIG. 13) discussed in the preceding paragraphs will now be described with reference to FIG. 15.

Like the host 1300, embodiments of the host 1502 include hardware, such as a communication interface, processing circuitry, and memory. The host 1502 also includes software, which is stored in or is accessible by the host 1502 and executable by the processing circuitry. The software includes a host application that may be operable to provide a service to a remote user, such as the UE 1506 connecting via an OTT connection 1550 extending between the UE 1506 and the host 1502. In providing the service to the remote user, a host application may provide user data which is transmitted using the OTT connection 1550.

The network node 1504 includes hardware enabling it to communicate with the host 1502 and the UE 1506 via a connection 1560. The connection 1560 may be direct or pass through a core network (like the core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by the UE 1506 and executable by the UE's processing circuitry. The software includes a client application, such as a web browser or operator-specific “app” that may be operable to provide a service to a human or non-human user via the UE 1506 with the support of the host 1502. In the host 1502, an executing host application may communicate with the executing client application via the OTT connection 1550 terminating at the UE 1506 and the host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via the connection 1560 between the host 1502 and the network node 1504 and via a wireless connection 1570 between the network node 1504 and the UE 1506 to provide the connection between the host 1502 and the UE 1506. The connection 1560 and the wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504 in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve, e.g., data rate, latency, and/or power consumption and thereby provide benefits such as, e.g., reduced user waiting time, relaxed restriction on file size, improved content resolution, better responsiveness, and/or extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR, or AR which it can broadcast, multicast, or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1550 between the host 1502 and the UE 1506 in response to variations in the measurement results. The measurement procedure and/or the network functionality for reconfiguring the OTT connection 1550 may be implemented in software and hardware of the host 1502 and/or the UE 1506. In some embodiments, sensors (not shown) may be deployed in or in association with other devices through which the OTT connection 1550 passes; the sensors may participate in the measurement procedure by supplying values of the monitored quantities exemplified above, or by supplying values of other physical quantities from which software may compute or estimate the monitored quantities. The reconfiguring of the OTT connection 1550 may include message format, retransmission settings, preferred routing, etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency, and the like by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### GROUP A EMBODIMENTS

Embodiment 1: A method performed by a User Equipment, UE, (902), the method comprising any one or more of: receiving (906), from a network node (900), a first indication of starting resource elements, REs, for a first subset of code division multiplexing, CDM, groups in a first set of time-frequency resource units; receiving (908), from the network node (900), a second indication of starting REs for a second subset of CDM groups in a second subset of time-frequency resource units; receiving (910) a first subset of non-zero power, NZP, channel state information reference signal, CSI-RS, ports in the first subset of CDM groups, in accordance with the first indication of the starting REs for the first subset of CDM groups in the first subset of time-frequency resource units; and receiving (912) a second subset of NZP CSI-RS ports in the second subset of CDM groups, in accordance with the second indication of the starting REs for the second subset of CDM groups in the second subset of time-frequency resource units.

Embodiment 2: The method of embodiment 1, wherein the first set of time-frequency resource units is a first subset of time-frequency resource units configured for a NZP CSI-RS resource, and the second set of time-frequency resource units is a second subset of time-frequency resource units configured for the NZP CSI-RS resource.

Embodiment 3: The method of embodiment 1, wherein the first set of time-frequency resource units is a first subset of time-frequency resource units configured for a first NZP CSI-RS resource, and the second set of time-frequency resource units is a second subset of time-frequency resource units configured for a second NZP CSI-RS resource.

Embodiment 4: The method of embodiment 3, wherein the first NZP CSI-RS resource and the second NZP CSI-RS resource are linked to form an overall CSI-RS resource.

Embodiment 5: The method of any of embodiments 1 to 4, wherein the first subset of time-frequency resource units comprises a first subset of PRBs in a slot, and the second subset of time-frequency resource units comprises a second subset of PRBs in the slot, wherein the first subset of PRBs in the slot is mutually exclusive to (i.e., does not overlap with) the second subset of PRBs in the slot.

Embodiment 6: The method embodiment 5, wherein the first subset of PRBs is the even PRBs and the second subset of PRBs is the odd PRBs.

Embodiment 7: The method of any of embodiments 1 to 6, wherein the first indication of the starting REs for the first subset of CDM groups in the first subset of time-frequency resource units comprises a first indication of starting subcarriers of the first subset of CDM groups in the first subset of time-frequency resource units, and the second indication of starting REs for the second subset of CDM groups in the second subset of time-frequency resource units comprises a second indication of staring subcarriers of the second subset of CDM groups in the second subset of time-frequency resource units.

Embodiment 8: The method of any of embodiments 1 to 7, wherein the number of CDM groups in the first subset of CDM groups is the same as the number of CDM group in the second subset of CDM groups.

Embodiment 9: The method of any of embodiments 1 to 7, wherein the number of CDM groups in the first subset of CDM groups is different than the number of CDM group in the second subset of CDM groups.

Embodiment 10: The method of any of embodiments 1 to 9, wherein the first indication and the second indication are separate bitmaps.

Embodiment 11: The method of any of embodiments 1 to 9, wherein the first indication and the second indication concatenated into a single bitmap.

Embodiment 12: The method of any of embodiments 1 to 9, wherein the first indication and the second indication are each a set or list of integer or enumerated values.

Embodiment 13: The method of any of embodiments 1 to 9, wherein the first indication and the second indication are a common configuration for both the first subset of CDM groups in the first subset of time-frequency resource units and the second subset of CDM groups in the second subset of time-frequency resource units.

Embodiment 14: The method of any of embodiments 1 to 4, wherein the first subset of time-frequency resource units comprises a plurality of PRBs in a first slot, and the second subset of time-frequency resource units comprises a plurality of PRBs in a second slot.

Embodiment 15: The method of embodiment 14, wherein the second slot is adjacent to the first slot.

Embodiment 16: The method of any of embodiments 14 to 15, wherein the first indication of starting REs comprises a first indication of starting symbols of the first subset of CDM groups, and the second indication of starting REs comprises a second indication of staring symbols of the second subset of CDM groups.

Embodiment 17: The method of any of embodiments 1 to 16, further comprising sending (904), to the network node (900), capability information comprising information that indicates that the UE supports CSI-RS resources with more than 32 ports.

Embodiment 18: The method of embodiment 17, wherein the capability information further comprises any one or more of the following information: maximum number of supported CSI-RS ports per CSI-RS resource, specific number of supported CSI-RS ports per CSI-RS resource, maximum number of PRB sets, support of PRB set specific starting subcarriers used for different CDM groups, support of different number of CDM groups in different PRB sets, support of transmitting different CSI-RS ports of the same CSI-RS resource in different slots, maximum number of slots the CSI-RS ports belonging to the same CSI-RS resource can be distributed over, support of slot specific starting symbol configuration for CDM groups in different, support of slot specific starting subcarriers for CDM groups in different slots.

Embodiment 19: The method of any of the previous embodiments, further comprising: providing user data; and forwarding the user data to a host via the transmission to the network node.

### GROUP B EMBODIMENTS

Embodiment 20: A method performed by a network node (900), the method comprising any one or more of the following: sending (906), to a User Equipment, UE, (902), a first indication of starting resource elements, REs, for a first subset of code division multiplexing, CDM, groups in a first set of time-frequency resource units; sending (908), to the UE (902), a second indication of starting REs for a second subset of CDM groups in a second subset of time-frequency resource units; transmitting (910), to the UE (902), a first subset of non-zero power, NZP, channel state information reference signal, CSI-RS, ports in the first subset of CDM groups, in accordance with the first indication of the starting REs for the first subset of CDM groups in the first subset of time-frequency resource units; and transmitting (912), to the UE (902), a second subset of NZP CSI-RS ports in the second subset of CDM groups, in accordance with the second indication of the starting REs for the second subset of CDM groups in the second subset of time-frequency resource units.

Embodiment 21: The method of embodiment 20, wherein the first set of time-frequency resource units is a first subset of time-frequency resource units configured for a NZP CSI-RS resource, and the second set of time-frequency resource units is a second subset of time-frequency resource units configured for the NZP CSI-RS resource.

Embodiment 22: The method of embodiment 20, wherein the first set of time-frequency resource units is a first subset of time-frequency resource units configured for a first NZP CSI-RS resource, and the second set of time-frequency resource units is a second subset of time-frequency resource units configured for a second NZP CSI-RS resource.

Embodiment 23: The method of embodiment 22, wherein the first NZP CSI-RS resource and the second NZP CSI-RS resource are linked to form an overall CSI-RS resource.

Embodiment 24: The method of any of embodiments 20 to 23, wherein the first subset of time-frequency resource units comprises a first subset of PRBs in a slot, and the second subset of time-frequency resource units comprises a second subset of PRBs in the slot, wherein the first subset of PRBs in the slot is mutually exclusive to (i.e., does not overlap with) the second subset of PRBs in the slot.

Embodiment 25: The method embodiment 24, wherein the first subset of PRBs is the even PRBs and the second subset of PRBs is the odd PRBs.

Embodiment 26: The method of any of embodiments 20 to 25, wherein the first indication of the starting REs for the first subset of CDM groups in the first subset of time-frequency resource units comprises a first indication of starting subcarriers of the first subset of CDM groups in the first subset of time-frequency resource units, and the second indication of starting REs for the second subset of CDM groups in the second subset of time-frequency resource units comprises a second indication of staring subcarriers of the second subset of CDM groups in the second subset of time-frequency resource units.

Embodiment 27: The method of any of embodiments 20 to 26, wherein the number of CDM groups in the first subset of CDM groups is the same as the number of CDM group in the second subset of CDM groups.

Embodiment 28: The method of any of embodiments 20 to 26, wherein the number of CDM groups in the first subset of CDM groups is different than the number of CDM group in the second subset of CDM groups.

Embodiment 29: The method of any of embodiments 20 to 28, wherein the first indication and the second indication are separate bitmaps.

Embodiment 30: The method of any of embodiments 20 to 28, wherein the first indication and the second indication concatenated into a single bitmap.

Embodiment 31: The method of any of embodiments 20 to 28, wherein the first indication and the second indication are each a set or list of integer or enumerated values.

Embodiment 32: The method of any of embodiments 20 to 28, wherein the first indication and the second indication are a common configuration for both the first subset of CDM groups in the first subset of time-frequency resource units and the second subset of CDM groups in the second subset of time-frequency resource units.

Embodiment 33: The method of any of embodiments 20 to 23, wherein the first subset of time-frequency resource units comprises a plurality of PRBs in a first slot, and the second subset of time-frequency resource units comprises a plurality of PRBs in a second slot.

Embodiment 34: The method of embodiment 33, wherein the second slot is adjacent to the first slot.

Embodiment 35: The method of any of embodiments 33 to 34, wherein the first indication of starting REs comprises a first indication of starting symbols of the first subset of CDM groups, and the second indication of starting REs comprises a second indication of staring symbols of the second subset of CDM groups.

Embodiment 36: The method of any of embodiments 20 to 35, further comprising receiving (904), from the UE (902), capability information comprising information that indicates that the UE supports CSI-RS resources with more than 32 ports.

Embodiment 37: The method of embodiment 36, wherein the capability information further comprises any one or more of the following information: maximum number of supported CSI-RS ports per CSI-RS resource, specific number of supported CSI-RS ports per CSI-RS resource, maximum number of PRB sets, support of PRB set specific starting subcarriers used for different CDM groups, support of different number of CDM groups in different PRB sets, support of transmitting different CSI-RS ports of the same CSI-RS resource in different slots, maximum number of slots the CSI-RS ports belonging to the same CSI-RS resource can be distributed over, support of slot specific starting symbol configuration for CDM groups in different, support of slot specific starting subcarriers for CDM groups in different slots.

Embodiment 38: The method of any of the previous embodiments, further comprising: obtaining user data; and forwarding the user data to a host or a user equipment.

### GROUP C EMBODIMENTS

Embodiment 39: A user equipment comprising: processing circuitry configured to perform any of the steps of any of the Group A embodiments; and power supply circuitry configured to supply power to the processing circuitry.

Embodiment 40: A network node comprising: processing circuitry configured to perform any of the steps of any of the Group B embodiments; and power supply circuitry configured to supply power to the processing circuitry.

Embodiment 41: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 42: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 43: The host of the previous embodiment, wherein the cellular network further includes a network node configured to communicate with the UE to transmit the user data to the UE from the host.

Embodiment 44: The host of the previous 2 embodiments, wherein: the processing circuitry of the host is configured to execute a host application, thereby providing the user data; and the host application is configured to interact with a client application executing on the UE, the client application being associated with the host application.

Embodiment 45: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 46: The method of the previous embodiment, further comprising: at the host, executing a host application associated with a client application executing on the UE to receive the user data from the UE.

Embodiment 47: The method of the previous embodiment, further comprising: at the host, transmitting input data to the client application executing on the UE, the input data being provided by executing the host application, wherein the user data is provided by the client application in response to the input data from the host application.

Embodiment 48: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 49: The host of the previous embodiment, wherein the cellular network further includes a network node configured to communicate with the UE to transmit the user data from the UE to the host.

Embodiment 50: The host of the previous 2 embodiments, wherein: the processing circuitry of the host is configured to execute a host application, thereby providing the user data; and the host application is configured to interact with a client application executing on the UE, the client application being associated with the host application.

Embodiment 51: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 52: The method of the previous embodiment, further comprising: at the host, executing a host application associated with a client application executing on the UE to receive the user data from the UE.

Embodiment 53: The method of the previous embodiment, further comprising: at the host, transmitting input data to the client application executing on the UE, the input data being provided by executing the host application, wherein the user data is provided by the client application in response to the input data from the host application.

Embodiment 54: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 55: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 56: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 57: The method of the previous embodiment, further comprising, at the network node, transmitting the user data provided by the host for the UE.

Embodiment 58: The method of any of the previous 2 embodiments, wherein the user data is provided at the host by executing a host application that interacts with a client application executing on the UE, the client application being associated with the host application.

Embodiment 59: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 60: The communication system of the previous embodiment, further comprising: the network node; and/or the user equipment.

Embodiment 61: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 62: The host of the previous 2 embodiments, wherein: the processing circuitry of the host is configured to execute a host application, thereby providing the user data; and the host application is configured to interact with a client application executing on the UE, the client application being associated with the host application.

Embodiment 63: The host of the any of the previous 2 embodiments, wherein the initiating receipt of the user data comprises requesting the user data.

Embodiment 64: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 65: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, a first indication of starting resource elements (REs) for a first subset of code division multiplexing (CDM) groups in a first set of time-frequency resource units;
receiving, from the network node, a second indication of starting REs for a second subset of CDM groups in a second set of time-frequency resource units;
receiving a first subset of non-zero power (NZP) channel state information reference signal (CSI-RS) ports in the first subset of CDM groups, in accordance with the first indication of the starting REs for the first subset of CDM groups in the first set of time-frequency resource units; and
receiving a second subset of NZP CSI-RS ports in the second subset of CDM groups, in accordance with the second indication of the starting REs for the second subset of CDM groups in the second set of time-frequency resource units.

2. (canceled)

3. The method of claim 1, wherein the first set of time-frequency resource units is configured for a first NZP CSI-RS resource, and the second set of time-frequency resource units is configured for a second NZP CSI-RS resource.

4. The method of claim 3, wherein the first NZP CSI-RS resource and the second NZP CSI-RS resource are linked to form an overall CSI-RS resource.

5. The method of claim 1, wherein the first set of time-frequency resource units comprises a first subset of Physical Resource Blocks (PRBs) in a slot, and the second set of time-frequency resource units comprises a second subset of PRBs in the slot, wherein the first subset of PRBs in the slot is mutually exclusive to the second subset of PRBs in the slot.

6. (canceled)

7. The method of claim 1, wherein the first indication of the starting REs for the first subset of CDM groups in the first set of time-frequency resource units comprises a first indication of starting subcarriers of the first subset of CDM groups in the first set of time-frequency resource units, and the second indication of starting REs for the second subset of CDM groups in the second set of time-frequency resource units comprises a second indication of staring subcarriers of the second subset of CDM groups in the second set of time-frequency resource units.

8.-9. (canceled)

10. The method of claim 1, wherein the first indication and the second indication are separate bitmaps.

11. (canceled)

12. The method of claim 1, wherein the first indication and the second indication are each a set or list of integer or enumerated values.

13.-19. (canceled)

20. The method of any of claim 1, further comprising sending, to the network node, capability information comprising information that indicates that the UE supports CSI-RS resources with more than 32 ports

21. The method of claim 20, wherein the capability information further comprises any one or more of the following information:
maximum number of supported CSI-RS ports per CSI-RS resource,
specific number of supported CSI-RS ports per CSI-RS resource,
maximum number of Physical Resource Block (PRB) sets,
support of PRB set specific starting subcarriers used for different CDM groups,
support of different number of CDM groups in different PRB sets,
support of transmitting different CSI-RS ports of the same CSI-RS resource in different slots,
maximum number of slots the CSI-RS ports belonging to the same CSI-RS resource can be distributed over,
support of slot specific starting symbol configuration for CDM groups in different slots, and
support of slot specific starting subcarriers for CDM groups in different slots.

22. A User Equipment (UE), adapted to:
receive, from a network node, a first indication of starting resource elements (REs) for a first subset of code division multiplexing (CDM) groups in a first set of time-frequency resource units;
receive, from the network node, a second indication of starting REs for a second subset of CDM groups in a second set of time-frequency resource units;
receive a first subset of non-zero power (NZP) channel state information reference signal (CSI-RS) ports in the first subset of CDM groups, in accordance with the first indication of the starting REs for the first subset of CDM groups in the first set of time-frequency resource units; and
receive a second subset of NZP CSI-RS ports in the second subset of CDM groups, in accordance with the second indication of the starting REs for the second subset of CDM groups in the second set of time-frequency resource units.

23.-25. (canceled)

26. A method performed by a network node, the method comprising:
sending, to a User Equipment (UE), a first indication of starting resource elements (REs) for a first subset of code division multiplexing (CDM) groups in a first set of time-frequency resource units;
sending, to the UE, a second indication of starting REs for a second subset of CDM groups in a second set of time-frequency resource units;
transmitting, to the UE, a first subset of non-zero power (NZP) channel state information reference signal (CSI-RS) ports in the first subset of CDM groups, in accordance with the first indication of the starting REs for the first subset of CDM groups in the first set of time-frequency resource units; and
transmitting, to the UE, a second subset of NZP CSI-RS ports in the second subset of CDM groups, in accordance with the second indication of the starting REs for the second subset of CDM groups in the second set of time-frequency resource units.

27. (canceled)

28. The method of claim 26, wherein the first set of time-frequency resource units is configured for a first NZP CSI-RS resource, and the second set of time-frequency resource units is configured for a second NZP CSI-RS resource.

29. The method of claim 28, wherein the first NZP CSI-RS resource and the second NZP CSI-RS resource are linked to form an overall CSI-RS resource.

30. The method of claim 26, wherein the first set of time-frequency resource units comprises a first subset of Physical Resource Blocks (PRBs) in a slot, and the second set of time-frequency resource units comprises a second subset of PRBs in the slot, wherein the first subset of PRBs in the slot is mutually exclusive to the second subset of PRBs in the slot.

31. (canceled)

32. The method of claim 26, wherein the first indication of the starting REs for the first subset of CDM groups in the first set of time-frequency resource units comprises a first indication of starting subcarriers of the first subset of CDM groups in the first set of time-frequency resource units, and the second indication of starting REs for the second subset of CDM groups in the second set of time-frequency resource units comprises a second indication of staring subcarriers of the second subset of CDM groups in the second set of time-frequency resource units.

33.-34. (canceled)

35. The method of claim 26, wherein the first indication and the second indication are separate bitmaps.

36. (canceled)

37. The method of claim 26, wherein the first indication and the second indication are each a set or list of integer or enumerated values.

38.-44. (canceled)

45. The method of claim 26, further comprising receiving, from the UE, capability information comprising information that indicates that the UE supports CSI-RS resources with more than 32 ports.

46. The method of claim 45, wherein the capability information further comprises any one or more of the following information:
maximum number of supported CSI-RS ports per CSI-RS resource,
specific number of supported CSI-RS ports per CSI-RS resource,
maximum number of Physical Resource Block (PRB) sets,
support of PRB set specific starting subcarriers used for different CDM groups,
support of different number of CDM groups in different PRB sets,
support of transmitting different CSI-RS ports of the same CSI-RS resource in different slots,
maximum number of slots the CSI-RS ports belonging to the same CSI-RS resource can be distributed over,
support of slot specific starting symbol configuration for CDM groups in different slots, and
support of slot specific starting subcarriers for CDM groups in different slots.

47. A network node adapted to:
send, to a User Equipment (UE), a first indication of starting resource elements (REs) for a first subset of code division multiplexing (CDM) groups in a first set of time-frequency resource units;
send, to the UE, a second indication of starting REs for a second subset of CDM groups in a second set of time-frequency resource units;
transmit, to the UE a first subset of non-zero power (NZP) channel state information reference signal (CSI-RS) ports in the first subset of CDM groups, in accordance with the first indication of the starting REs for the first subset of CDM groups in the first set of time-frequency resource units; and
transmit, to the UE, a second subset of NZP CSI-RS ports in the second subset of CDM groups, in accordance with the second indication of the starting REs for the second subset of CDM groups in the second set of time-frequency resource units.

48.-50. (canceled)
